(19) United States
(12) Patent Application Publication
(10) Pub. No.: US 2026/0242597 A1
(43) Pub. Date: Aug. 20, 2026

(54) POLYURETHANE FOAM AND VEHICULAR INTERIOR MEMBER

(71) Applicant: INOAC CORPORATION, Nagoya-shi, Aichi (JP)

(72) Inventor: Akane KAMMURA, Aichi (JP)

(73) Assignee: INOAC CORPORATION, Nagoya-shi, Aichi (JP)

(21) Appl. No.: 19/161,400

(22) PCT Filed: Mar. 1, 2024
(86) PCT No.: PCT/JP2024/007718

§ 371 Date: Sep. 2, 2025

(30) Foreign Application Priority Data
Mar. 8, 2023 (JP) 2023-035388

(51) Int. Cl. C08L 75/08; B60N 2/58; C08G 18/40; C08G 18/42; C08G 18/48; C08G 18/76; C08J 9/00; C08J 9/12

(52) U.S. Cl. CPC C08L 75/08; B60N 2/5891; C08G 18/4018; C08G 18/42; C08G 18/4829; C08G 18/7621; C08J 9/0061; C08J 9/127; C08J 2203/10; C08J 2203/14; C08J 2203/182; C08J 2375/08; C08J 2491/08; C08L 2203/14

(57) ABSTRACT

The air permeability of a polyurethane foam is improved while reducing a cyclic siloxane or without using a cyclic siloxane. The polyurethane foam is obtained from a composition obtained by mixing a polyol, a polyisocyanate, and a tin catalyst. The composition contains a hydrocarbon having 5 or more and 50 or less carbon atoms.

### TECHNICAL FIELD

The present disclosure relates to a polyurethane foam and a vehicular interior member.

The present application is based on and claims the benefit of priority of Japanese Patent Application No. 2023-35388 filed on Mar. 8, 2023, the entire contents of which are incorporated herein by reference.

### BACKGROUND ART

Patent Literature 1 discloses a technique of adding a cyclic siloxane for improving the air permeability of a polyurethane foam.

### CITATIONS LIST

### Patent Literature

Patent Literature 1: JP 2011-037987 A

### SUMMARY OF INVENTION

### Technical Problems

However, cyclic siloxanes are subjected to various kinds of regulations. The 19th update of the SVHC (substances of very high concern) list of the European REACH Regulation includes decamethylcyclopentasiloxane, dodecamethylcyclohexasiloxane, and octamethylcyclotetrasiloxane.

The present disclosure has been made in view of the above circumstances, and it is an object of the present disclosure to improve the air permeability of a polyurethane foam while reducing a cyclic siloxane or without using a cyclic siloxane. The present disclosure can be implemented in the following forms.

### Solutions to Problems

[1]

A polyurethane foam obtained from a composition obtained by mixing:
a polyol;
a polyisocyanate; and
a tin catalyst, in which the composition contains a hydrocarbon having 5 or more and 50 or less carbon atoms.

### Advantageous Effects of Invention

With the present disclosure, the air permeability of a polyurethane foam can be improved while reducing a cyclic siloxane or without using a cyclic siloxane.

### BRIEF DESCRIPTION OF DRAWING

FIG. 1 shows a vehicular interior member including a polyurethane foam according to an embodiment.

### DESCRIPTION OF EMBODIMENT

Desirable examples of the present disclosure will now be described.

[2]

The polyurethane foam according to [1], in which a polyester polyol is contained as the polyol.

[3] The polyurethane foam according to [1] or [2], in which the composition contains a flame retardant.
[4] The polyurethane foam according to any one of [1] to [3], having an air flow value based on Method A of JIS K 6400-7:2012 of 25 L/min or more.
[5]

The polyurethane foam according to any one of [1] to [4], in which the composition contains 5.0 parts by mass or less of the hydrocarbon based on 100 parts by mass of the polyol.

[6]

A vehicular interior member including the polyurethane foam according to any one of [1] to [5].

Hereinafter, the present disclosure will be described in detail. In the present specification, the description of a numerical range using “-” includes the lower limit and the upper limit unless otherwise specified. For example, the expression “10-20” includes both the lower limit “10” and the upper limit “20”. That is, “10-20” has the same meaning as “10 or more and 20 or less”. In the present specification, the upper limits and the lower limits of respective numerical ranges can be arbitrarily combined.

### 1. Polyurethane Foam

The polyurethane foam is obtained from a composition (hereinafter also referred to as a polyurethane resin composition) obtained by mixing a polyol, a polyisocyanate, and a tin catalyst. The composition contains a hydrocarbon having 5 or more and 50 or less carbon atoms.

### (1) Polyol

The polyol is not particularly limited. Various polyols may be used singly or in combination of two or more kinds thereof.

Examples of the polyol include a polyether polyol, a polyester polyol, a polyether ester polyol, a polycarbonate diol, and a polyol whose main chain is formed by carbon-carbon bonds.

Examples of the polyether polyol include polyoxypropylene-polyoxyethylene polyol, polymer polyols, and polyoxytetramethylene glycol.

Examples of the polyester polyol include aliphatic or aromatic polycondensation polyester polyols and polycaprolactone polyols.

Examples of the polyol whose main chain is formed by carbon-carbon bonds include polyolefin-based polyols such as polybutadiene polyols and isoprene polyols, and acrylic polyols.

### (1.1) Polyether Polyol

Examples of the polyether polyol include a polyether polyol obtained by adding one or two or more of ethylene oxide, propylene oxide, butylene oxide, tetrahydrofuran, epichlorohydrin, styrene oxide, and the like to one or two or more of the following initiators (compounds), and polytetramethylene ether glycol.

### (1.1.1) Initiator

### (1.1.1.1) Polyhydric Alcohol and Alkylene Oxide Adduct of Polyhydric Alcohol

Examples of polyhydric alcohol:
[Bifunctional alcohol] ethylene glycol, propylene glycol, diethylene glycol, triethylene glycol, dipropylene glycol, trimethylene glycol
[Trifunctional alcohol] glycerin, trimethylolpropane
[Tetrafunctional alcohol] pentaerythritol
[Hexafunctional alcohol] sorbitol
[Octafunctional alcohol] sucrose

### (1.1.1.2) Alkylene Oxide Adduct of Polyhydric Phenol

Examples of alkylene oxide adduct of polyhydric phenol: alkylene oxide adducts of bisphenol A

### (1.1.1.3) Polyhydroxy Compound

Examples of polyhydroxy compound: phosphoric acid, benzene phosphoric acid, polyphosphoric acid (such as tripolyphosphoric acid and tetrapolyphosphoric acid), and the like

### (1.1.1.4) Phenol-Aniline-Formaldehyde Ternary Condensation Product

### (1.1.1.5) Aniline-Formaldehyde Condensation Product

### (1.1.1.6) Polyamine

Examples of polyamine: ethylenediamine, diethylenetriamine, triethylenetetramine, methylenebis(o-chloroaniline), 4,4- and 2,4′-diphenylmethanediamine, 2,4-tolylenediamine, 2,6-tolylenediamine, and the like

### (1.1.1.7) Alkanolamine

Examples of alkanolamine: triethanolamine, diethanolamine, and the like

### (1.1.2) Polymer Polyol

The polymer polyol is a polyol obtained by graft-polymerizing an ethylenically unsaturated compound such as acrylonitrile, styrene, and an alkyl methacrylate with the above-described polyether polyol.

### (1.2) Polyester Polyol

The polyester polyol is a polyester polyol obtained by condensation of one or two or more of compounds having at least two hydroxy groups with one or two or more of compounds having at least two carboxyl groups, or a ring-opened polymer of a cyclic ester such as caprolactone and methylvalerolactone.

### (1.2.1) Examples of Compound Having at Least Two Hydroxy Groups

Ethylene glycol, diethylene glycol, triethylene glycol, propylene glycol, dipropylene glycol, trimethylene glycol, 1,3-butanediol, 1,4-butanediol, tetramethylene glycol, neopentyl glycol, methylpentanediol, butylethylpropanediol, hexamethylene glycol, decamethylene glycol, glycerin, trimethylolpropane, pentaerythritol, sorbitol

### (1.2.2) Examples of Compound Having at Least Two Carboxyl Groups

Malonic acid, maleic acid, succinic acid, adipic acid, tartaric acid, pimelic acid, azelaic acid, sebacic acid, oxalic acid, phthalic acid, isophthalic acid, terephthalic acid, trimellitic acid, hemellitic acid

### (1.3) Polycarbonate Polyol

Examples of the polycarbonate polyol include those obtained by transesterification of a low-molecular polyol such as butanediol and hexanediol with a low-molecular carbonate such as propylene carbonate and diethyl carbonate.

### (1.4) Polyolefin-Based Polyol

Examples of the polyolefin-based polyol include polybutadiene polyol, polyisoprene polyol, hydrogenated polybutadiene polyol, and hydrogenated polyisoprene polyol.

### (1.5) Plant-Derived Polyol

As the polyol, a plant-derived polyol may be contained in addition to the polyol described above. Examples of the plant-derived polyol include a castor oil-based polyol, a soybean oil-based polyol, a palm oil-based polyol, a palm kernel oil-based polyol, a coconut oil-based polyol, a cashew oil-based polyol, an olive oil-based polyol, a cottonseed oil-based polyol, a safflower oil-based polyol, a sesame oil-based polyol, a sunflower oil-based polyol, and a linseed oil-based polyol. In plant-derived polyols, the number of functional groups of hydroxy groups in one molecule is usually 2-3.

Examples of the castor oil-based polyol include castor oil, a reaction product of castor oil and a polyol, and an esterification reaction product of castor oil fatty acid and a polyol. Examples of the polyol to be reacted with castor oil or castor oil fatty acid include dihydric polyols such as ethylene glycol, diethylene glycol, and propylene glycol, and trihydric or higher polyols such as glycerin, trimethylolpropane, hexanetriol, and sorbitol.

Examples of the soybean oil-based polyol include a polyol derived from soybean oil, such as a reaction product of soybean oil and a polyol, and an esterification reaction product of soybean oil fatty acid and a polyol. As the polyol to be reacted with soybean oil or soybean oil fatty acid, the same polyol as in the case of the castor oil can be used. The same applies to palm oil-based polyols, cashew oil-based polyols, and the like as in the case of soybean oil-based polyols. The various polyols exemplified as the plant-derived polyols may be used singly or in combination of two or more kinds thereof.

### (1.6) Application to Flame Lamination Method

When the polyurethane foam is used in the flame lamination method, a polyester polyol is preferably contained as the polyol.

The flame lamination method is a method for bonding another member such as a surface material to a polyurethane foam. In the flame lamination method, a surface of a polyurethane foam is melted by applying flame to develop adhesiveness in the melted portion, so that another member is bonded to the polyurethane foam. When the polyester polyol is contained, the polyurethane foam is easily melted by flame, and sufficient adhesiveness can be obtained. The polyester polyol is not limited to use for the flame lamination method. For example, the polyester polyol may be used for the purpose of adjusting various physical properties of the polyurethane foam.

The content of the polyester polyol is not particularly limited. The content of the polyester polyol is preferably 0.5 parts by mass or more and 20 parts by mass or less, more preferably 1 part by mass or more and 15 parts by mass or less, still more preferably 3 parts by mass or more and 10 parts by mass or less when the total amount of the polyols is 100 parts by mass.

The weight average molecular weight of the polyester polyol is not particularly limited. The number average molecular weight of the polyester polyol is preferably 200 or more and 4500 or less, more preferably 500 or more and 3500 or less, still more preferably 800 or more and 2500 or less. The weight average molecular weight of the polyester polyol can be measured by the gel permeation chromatography (GPC) method. When the polyol is a commercially available product, a catalog value may be employed as the weight average molecular weight.

The hydroxyl value of the polyester polyol is not particularly limited. The hydroxyl value of the polyester polyol is preferably 80 mg KOH/g or more and 350 mg KOH/g or less, more preferably 100 mg KOH/g or more and 300 mg KOH/g or less, still more preferably 150 mg KOH/g or more and 250 mg KOH/g or less.

The number of functional groups of the polyester polyol is not particularly limited. The number of functional groups of the polyester polyol is preferably 2.0 or more, more preferably 2.1 or more, still more preferably 2.2 or more. The number of functional groups of the polyester polyol is, for example, 4.0 or less.

The polyester polyol is preferably used in combination with a polyether polyol from the viewpoint of securing the flexibility of the polyurethane foam. The polyether polyol used in combination with the polyester polyol is not particularly limited.

The content of the polyether polyol to be used in combination is, for example, preferably 80 parts by mass or more and 99.5 parts by mass or less, more preferably 85 parts by mass or more and 99 parts by mass or less, still more preferably 90 parts by mass or more and 97 parts by mass or less when the total amount of the polyols is 100 parts by mass.

The weight average molecular weight, hydroxyl value, and number of functional groups of the polyether polyol to be used in combination are not particularly limited.

The weight average molecular weight of the above polyether polyol is preferably 500 or more and 10,000 or less, more preferably 1000 or more and 6000 or less, still more preferably 1500 or more and 4000 or less. The weight average molecular weight of the polyether polyol can be measured by the gel permeation chromatography (GPC) method.

The hydroxyl value of the polyether polyol is preferably 40 mg KOH/g or more and 300 mg KOH/g or less, more preferably 45 mg KOH/g or more and 150 mg KOH/g or less, still more preferably 50 mg KOH/g or more and 80 mg KOH/g or less.

The number of functional groups of the above polyether polyol is preferably 2.0 or more, more preferably 2.1 or more, still more preferably 2.2 or more. The number of functional groups of the polyester polyol is, for example, 4.0 or less.

### (2) Catalyst

The polyurethane resin composition contains a tin catalyst. The inventor of the present application has conducted intensive studies based on the finding that when the blending amount of the tin catalyst increases, the air permeability of the polyurethane foam decreases. Then, the present inventor has newly found that the air permeability of a polyurethane foam can be improved by blending a hydrocarbon also when a tin catalyst is blended, and has developed the technology of the present disclosure.

As the tin catalyst, one or more selected from the group consisting of tin(II) octylate (tin 2-ethylhexanoate, stannous dioctoate), tin(II) acetate, tin(II) octoate, stannous dioleate, tin(II) neodecanoate, stannous dilaurate, dibutyltin oxide, dibutyltin diacetate, dibutyltin dilaurate, dibutyltin dichloride, dioctyltin dilaurate, dibutyltin dimaleate, and dioctyltin diacetate can be used.

The blending amount of the tin catalyst in the polyurethane resin composition is not particularly limited. The blending amount of the tin catalyst is preferably 0.01 parts by mass or more, more preferably 0.03 parts by mass or more, still more preferably 0.06 parts by mass or more with respect to 100 parts by mass of the polyol from the viewpoint of sufficiently accelerating the reaction for producing polyurethane. On the other hand, the blending amount is preferably 1.0 part by mass or less, more preferably 0.5 parts by mass or less, still more preferably 0.2 parts by mass or less from the viewpoint of retaining various physical properties of the polyurethane foam and the viewpoint of production cost. From these viewpoints, the blending amount of the tin catalyst is preferably 0.01 parts by mass or more and 1.0 part by mass or less, more preferably 0.03 parts by mass or more and 0.5 parts by mass or less, still more preferably 0.06 parts by mass or more and 0.2 parts by mass or less with respect to 100 parts by mass of the polyol. Furthermore, the blending amount of the tin catalyst may be 0.17 parts by mass or less, 0.15 parts by mass or less, or 0.13 parts by mass or less.

The tin catalyst may be used singly or in combination with another catalyst.

As the other catalyst, an amine catalyst and a quaternary ammonium salt catalyst can be used. Specific examples of these catalysts are shown.

Tertiary amine catalysts such as triethylenediamine, triethylamine, tripropylamine, triisopropanolamine, tributylamine, trioctylamine, hexadecyldimethylamine, N-methylmorpholine, N-ethylmorpholine, N-octadecylmorpholine, monoethanolamine, diethanolamine, triethanolamine, N-methyldiethanolamine, N,N-dimethylethanolamine, N,N-dimethylaminohexanol, N,N-dimethylaminoethoxyethoxyethanol, and N,N-dimethylaminoethoxyethanol, formate and other salts of triethylenediamine, oxyalkylene adducts of amino groups of primary and secondary amines, aza-ring compounds such as N—N-dialkylpiperazines, various N,N′,N′-trialkylaminoalkylhexahydrotriazines, and amine catalysts having an amino group as a functional group, such as N,N,N″,N″-tetramethyldiethylenetriamine, can be employed.

In addition, quaternary ammonium salt catalysts such as tetraalkylammonium halides such as tetramethylammonium chloride, tetraalkylammonium hydroxides such as tetramethylammonium hydroxide, and tetraalkylammonium organic acid salts such as tetramethylammonium 2-ethylhexanoate, 2-hydroxypropyltrimethylammonium formate, and 2-hydroxypropyltrimethylammonium 2-ethylhexanoate can also be employed.

The blending amount of one or more catalysts selected from the group consisting of amine catalysts and quaternary ammonium salt catalysts in the polyurethane resin composition is not particularly limited. The blending amount of these catalysts is preferably 0.01 parts by mass or more, more preferably 0.05 parts by mass or more, still more preferably 0.09 parts by mass or more with respect to 100 parts by mass of the polyol from the viewpoint of sufficiently accelerating the reaction for producing polyurethane. On the other hand, the blending amount is preferably 3.0 parts by mass or less, more preferably 2.0 parts by mass or less, still more preferably 1.0 part by mass or less from the viewpoint of retaining various physical properties of the polyurethane foam and the viewpoint of production cost. From these viewpoints, the blending amount of one or more catalysts selected from the group consisting of amine catalysts and quaternary ammonium salt catalysts is preferably 0.01 parts by mass or more and 3.0 parts by mass or less, more preferably 0.05 parts by mass or more and 2.0 parts by mass or less, still more preferably 0.01 parts by mass or more and 1.0 part by mass or less with respect to 100 parts by mass of the polyol.

The polyurethane resin composition may contain a metal catalyst other than the tin catalyst. As the metal catalyst other than the tin catalyst, a conventionally known metal catalyst can be employed without particular limitation.

As the metal catalyst other than the tin catalyst, for example, a salt of a metal such as Pb (lead), Bi (bismuth), Ni (nickel), Co (cobalt), Fe (iron), Zr (zirconium), Cu (copper), and Zn (zinc), an organic acid metal salt, or the like can be used. More specifically, the following metal catalyst can be used.
Pb catalyst: lead octanoate, lead naphthenate, and the like
Bi catalyst: bismuth octylate, bismuth naphthenate, bismuth neodecanoate, bismuth rosinate, and the like
Fe catalyst: iron acetylacetonate and the like
Zr catalyst: zirconium acetylacetonate and the like
Ni catalyst: nickel acetylacetonate, nickel octylate, nickel naphthenate, and the like
Co catalyst: cobalt acetylacetonate, cobalt octylate, cobalt naphthenate, and the like

### (3) Flame Retardant

The polyurethane resin composition preferably contains a flame retardant. The flame retardant is not particularly limited. Examples of the flame retardant include one or more selected from the group consisting of a phosphate ester-based flame retardant, a phosphate salt-containing flame retardant, a red phosphorus, a bromine-containing flame retardant, a boric acid-containing flame retardant, an antimony-containing flame retardant, and a metal hydroxide.

The flame retardant is preferably a phosphate ester-based flame retardant from the viewpoint of improving flame retardancy. The phosphate ester-based flame retardant may be a halogen-based phosphate ester-based flame retardant or a non-halogen-based phosphate ester-based flame retardant. The halogen-based phosphate ester-based flame retardant is preferably, for example, one or more selected from the group consisting of a condensate of tris-1-chloro-2-propyl phosphate (TCPP), a condensate of tris-2-chloroethyl phosphate (TCEP), and a condensate of tris-1,3-dichloro-2-propyl phosphate (TDCP). Among them, a condensate of TCPP is more preferable from the viewpoint of safety, flame retardancy, and fogging resistance.

The blending amount of the flame retardant is not particularly limited. The blending amount of the flame retardant is preferably 3 parts by mass or more, more preferably 8 parts by mass or more, still more preferably 13 parts by mass or more with respect to 100 parts by mass of the polyol from the viewpoint of securing sufficient flame retardancy. On the other hand, the blending amount is preferably 28 parts by mass or less, more preferably 25 parts by mass or less, still more preferably 22 parts by mass or less from the viewpoint of retaining various physical properties of the polyurethane foam and the viewpoint of production cost. From these viewpoints, the blending amount of the flame retardant is preferably 3 parts by mass or more and 28 parts by mass or less, more preferably 8 parts by mass or more and 25 parts by mass or less, still more preferably 13 parts by mass or more and 22 parts by mass or less with respect to 100 parts by mass of the polyol.

### (4) Foam Stabilizer

The polyurethane resin composition may contain a foam stabilizer. The foam stabilizer is not particularly limited.

Specific examples of the foam stabilizer include a silicone-based compound such as an organopolysiloxane, an organopolysiloxane-polyoxyalkylene copolymer, a polyalkenyl siloxane having a polyoxyalkylene side chain, and a silicone-grease copolymer, an anionic surfactant such as sodium dodecylbenzenesulfonate and sodium lauryl sulfate, a polyether siloxane, and a phenol-based compound. These foam stabilizers may be used singly or in combination of two or more kinds thereof.

The blending amount of the foam stabilizer is not particularly limited. The blending amount of the foam stabilizer is preferably 0.03 parts by mass or more and 5.0 parts by mass or less with respect to 100 parts by mass of the polyol.

### (5) Foaming Agent

The polyurethane resin composition may contain a foaming agent. The foaming agent is not particularly limited. As the foaming agent, water, pentane, cyclopentane, hexane, cyclohexane, dichloromethane, carbon dioxide gas, or the like is suitably used. When the foaming agent is water, the addition amount is determined within a range in which a desired density and a good foamed state can be obtained in the polyurethane foam, and is usually preferably 1 part by mass or more and 10 parts by mass or less with respect to 100 parts by mass of the polyol.

### (6) Polyisocyanate

The polyisocyanate is not particularly limited. As the polyisocyanate, at least one selected from the group consisting of aromatic isocyanates, alicyclic isocyanates, and aliphatic isocyanates is suitably employed. One or more kinds of aliphatic isocyanates and one or more kinds of aromatic isocyanates may be used in combination.

The polyisocyanate may be either a bifunctional polyisocyanate having two isocyanate groups in one molecule or a trifunctional or higher polyisocyanate having three or more isocyanate groups in one molecule, and may be used singly or in combination of two or more thereof.

Examples of the bifunctional polyisocyanate include aromatic isocyanates such as 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, xylylene diisocyanate, 3,3′-dimethyl-4,4′-biphenylene diisocyanate, and 3,3′-dimethoxy-4,4′-biphenylene diisocyanate; alicyclic isocyanates such as cyclohexane-1,4-diisocyanate, isophorone diisocyanate, dicyclohexylmethane-4,4′-diisocyanate, and methylcyclohexane diisocyanate; and aliphatic isocyanates such as butane-1,4-diisocyanate, hexamethylene diisocyanate, isopropylene diisocyanate, methylene diisocyanate, and lysine isocyanate.

Examples of the trifunctional or higher polyisocyanate include 1-methylbenzol-2,4,6-triisocyanate, 1,3,5-trimethylbenzol-2,4,6-triisocyanate, biphenyl-2,4,4′-triisocyanate, diphenylmethane-2,4,4′-triisocyanate, methyldiphenylmethane-4,6,4′-triisocyanate, 4,4′-dimethyldiphenylmethane-2,2′,5,5′-tetraisocyanate, triphenylmethane-4,4′,4″-triisocyanate, and polymeric MDI.

In addition, urethane prepolymers, carbodiimide-modified isocyanates, isocyanurate-modified isocyanates, and biuret-modified isocyanates can also be used.

The mixing ratio of the polyisocyanate and the polyol is not particularly limited. The isocyanate index is preferably 80 or more and 120 or less. The isocyanate index (INDEX) is a value obtained by multiplying the number of moles of isocyanate groups per 1 mol of active hydrogen groups contained in the polyurethane resin composition by 100, and is calculated by [(isocyanate equivalent in composition/equivalent of active hydrogen in composition)×100].

### (7) Hydrocarbon Having 5 or More and 50 or Less Carbon Atoms

The hydrocarbon having 5 or more and 50 or less carbon atoms is not particularly limited as long as the carbon number is within this range. The hydrocarbon may be either a saturated hydrocarbon or an unsaturated hydrocarbon. The hydrocarbon may be either a hydrocarbon having a branched structure or a cyclic hydrocarbon. Preferable examples of the hydrocarbon include n-paraffins having 5 or more and 50 or less carbon atoms and isoparaffins having 5 or more and 50 or less carbon atoms. The hydrocarbon having 5 or more and 50 or less carbon atoms may be used singly, or may be used as a mixture of two or more thereof.

(7.1) n-Paraffin Having 5 or More and 50 or Less Carbon Atoms

Examples of the n-paraffin having 5 or more and 50 or less carbon atoms include at least one selected from the group consisting of n-nonane, n-decane, n-undecane, n-dodecane, n-tridecane, n-tetradecane, n-pentadecane, n-hexadecane, n-heptadecane, n-octadecane, n-nonadecane, and n-eicosane.

### (7.2) Isoparaffin Having 5 or More and 50 or Less Carbon Atoms

Examples of the isoparaffin having 5 or more and 50 or less carbon atoms include at least one selected from the group consisting of isodecane, isododecane, 7-methyldecane, and 7-n-hexyltridecane.

### (7.3) Blending Amount of Hydrocarbon Having 5 or More and 50 or Less Carbon Atoms

The blending amount of the hydrocarbon having 5 or more and 50 or less carbon atoms in the polyurethane resin composition is not particularly limited as long as the hydrocarbon is blended. The blending amount of the hydrocarbon is preferably 0.1 parts by mass or more, more preferably 0.2 parts by mass or more, still more preferably 0.3 parts by mass or more with respect to 100 parts by mass of the polyol from the viewpoint of sufficiently securing the air permeability of the polyurethane foam. On the other hand, the blending amount is preferably 5.0 parts by mass or less, more preferably 3.0 parts by mass or less, still more preferably 1.0 part by mass or less from the viewpoint of retaining various physical properties of the polyurethane foam and the viewpoint of production cost. From these viewpoints, the blending amount of the hydrocarbon is preferably 0.1 parts by mass or more and 5.0 parts by mass or less, more preferably 0.2 parts by mass or more and 3.0 parts by mass or less, still more preferably 0.3 parts by mass or more and 1.0 part by mass or less with respect to 100 parts by mass of the polyol. When two or more kinds of hydrocarbons are used, the blending amount means the total amount of all the hydrocarbons.

### (8) Other Additives

In the polyurethane resin composition, other additives such as a crosslinking agent, a plasticizer, a filler, an antioxidant, an ultraviolet absorber, a defoaming agent, a compatibilizer, a colorant, a stabilizer, an antibacterial agent, an antifungal agent, a deodorant, a deodorizer, an aromatic, and a perfume can be appropriately blended. Examples of the crosslinking agent include short chain diol crosslinking agents such as ethylene glycol, diethylene glycol, propylene glycol, dipropylene glycol, 1,4-butanediol, glycerin, and trimethylolpropane. Examples of the colorant include a pigment, a dye, and a coloring.

### (9) Reason why Air Permeability of Polyurethane Foam is Improved

The reason why the air permeability is improved will be described. It is presumed that since the polyurethane resin composition contains a hydrocarbon having 5 or more and 50 or less carbon atoms, many cell membranes are broken during foaming process of the polyurethane foam. It is considered that high air permeability of the polyurethane foam is therefore secured.

### (10) Physical Properties of Polyurethane Foam

The physical properties of the polyurethane foam can be appropriately set according to the application and the like. The polyurethane foam is preferably a flexible polyurethane foam.

The polyurethane foam preferably has the following physical properties.

### (10.1) Apparent Density

The apparent density (JIS K 7222:2005) is preferably 8 kg/m³-120 kg/m³, more preferably 10 kg/m³-80 kg/m³, still more preferably 15 kg/m³-45 kg/m³.

### (10.2) Hardness

The hardness (Method D of JIS K 6400-2:2012) is preferably 10 N-600 N, more preferably 50 N-300 N, still more preferably 80 N-150 N. Within this range, flexibility is excellent, and a preferable flexible polyurethane foam is obtained.

### (10.3) Rebound Resilience

The rebound resilience (JIS K 6400-3:2011) is preferably 1%-80%, more preferably 5%-70%, still more preferably 15%-60%.

(10.4) Tensile Strength, Elongation, and Tear strength

The tensile strength (JIS K 6400-5:2012) is preferably 30 kPa or more, more preferably 50 kPa or more, still more preferably 70 kPa or more. The upper limit of the tensile strength is not particularly limited, and is, for example, 500 kPa or less.

The elongation (JIS K 6400-5:2012) is preferably 80%-500%. When the elongation is 80% or more, flexibility is excellent, and a preferable flexible polyurethane foam is obtained.

The tear strength (JIS K 6400-5:2012) is preferably 2.0 N/cm or more, more preferably 3.0 N/cm or more, still more preferably 4.0 N/cm or more. The upper limit of the tear strength is not particularly limited, and is, for example, 50 N/cm or less.

### (10.5) Air Flow Value

The air flow value (Method A of JIS K 6400-7:2012) is preferably 25 L/min or more, more preferably 60 L/min or more, still more preferably 100 L/min or more. The air flow value is usually 300 L/min or less.

### 2. Production of Polyurethane Foam

The polyurethane foam can be produced by a known foaming method in which a polyurethane resin composition is stirred and mixed to react a polyol with a polyisocyanate. The foaming method includes slab foaming and mold foaming, and any molding method may be used. Slab foaming is a method in which a mixed polyurethane resin composition is discharged onto a belt conveyor and foamed at normal temperature under atmospheric pressure. On the other hand, mold foaming is a method in which a mixed polyurethane resin composition is filled into a mold (molding die) and foamed inside the mold.

### 3. Application of Polyurethane Foam

The application of the polyurethane foam is not particularly limited. The hydrocarbon used in the polyurethane foam of the present embodiment is easily decomposed and has a low environmental load, and thus is useful for various applications.

The polyurethane foam of the present embodiment can improve the air permeability of the polyurethane foam while reducing a cyclic silicone or without using a cyclic silicone, and thus is suitable as a vehicular interior member. The polyurethane foam of the present embodiment is also suitable as a vehicular interior member from the viewpoint of being able to contribute to the reduction of volatile organic compounds (VOCs) and the like.

The vehicular interior member is not particularly limited. Examples of the vehicular interior member include a member used for a vehicle seat and a member used for an interior material for a vehicle.

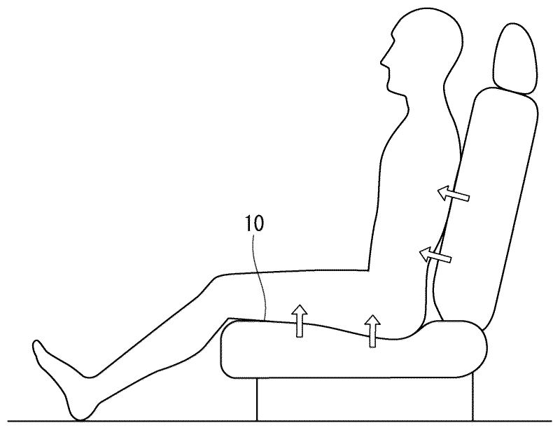

FIG. 1 illustrates an upholstery material 10 used for a vehicle seat as an example of a vehicular interior member. The upholstery material 10 includes a surface material made of a material such as real leather, synthetic leather, and fabric, and a polyurethane foam bonded to the surface material. Such an upholstery material is suitable as an upholstery material of an air-conditioned seat provided with a heater unit, a cooling unit, or the like. That is, when the polyurethane foam of the present embodiment is used as the upholstery material of an air-conditioned seat, the air permeability of the upholstery material can be sufficiently secured, and the energy efficiency of the air-conditioned seat can be improved. The arrows in FIG. 1 schematically represent the flows of air of the air-conditioned seat. Note that the air flows may be in directions opposite to the arrows in FIG. 1.

### EXAMPLES

### 1. Production of Polyurethane Foam

Polyurethane resin compositions blended in the proportions shown in Table 1 were prepared, and polyurethane foams of comparative examples, reference examples, and examples were produced by slab foaming. The reference examples are comparative examples in which the compositions did not contain a hydrocarbon having 5 or more and 50 or less carbon atoms.

Details of each raw material are as follows.
Polyol 1: polyether polyol, number of functional groups: 3, weight average molecular weight: 3000, hydroxyl value: 56 mg KOH/g
Polyol 2: polyester polyol, weight average molecular weight 2400, hydroxyl value: 205 mg KOH/g, DG196AX, manufactured by C.O.I.M. S.p.A.
Foaming agent: water
Amine catalyst: N,N-dimethylaminohexanol
Foam stabilizer: silicone-based foam stabilizer, product name: SZ-1136, manufactured by Dow Corning Toray Co., Ltd.
Flame retardant: condensate of tris(1-chloro-2-propyl) phosphate (TCPP), CR-504L, manufactured by Daihachi Chemical Industry Co., Ltd.
Antioxidant 1: phenolic antioxidant, Songox 1135, manufactured by SONGWON Industrial Co., Ltd.
Antioxidant 2: CS-25LF, manufactured by Momentive Performance Materials Inc.
Pigment: black 4114 TT
Isocyanate: tolylene diisocyanate (mixture of 80 mass % of 2,4-tolylene diisocyanate and 20 mass % of 2,6-tolylene diisocyanate)
Tin catalyst: tin(II) octylate
Cyclic siloxane: cyclopentasiloxane, SH245, manufactured by Dow Corning Toray Co., Ltd.
Hydrocarbon: n-dodecane, C₁₂H₂₆

Specifically, the polyurethane foams were produced by the following procedure.

Raw materials other than the polyisocyanate were weighed and stirred in a cup container to provide a mixed solution.

The polyisocyanate was added to the mixed solution and stirred to provide a polyurethane resin composition.

TABLE 1

| | | | Comparative | Comparative | Comparative | Reference | Reference | Reference |
|---|---|---|---|---|---|---|---|---|
| | | | Example 1 | Example 2 | Example 3 | Example 1 | Example 2 | Example 3 |
| Blending | Polyol 1 | [ Parts by mass] | 100 | 100 | 100 | 100 | 100 | 100 |
| ratio | Polyol 2 | [ Parts by mass] | 5.0 | 5.0 | 5.0 | 5.0 | 5.0 | 5.0 |
| | Foaming agent | [ Parts by mass] | 4.7 | 4.7 | 4.7 | 4.7 | 4.7 | 4.7 |
| | Amine catalyst | [ Parts by mass] | 0.15 | 0.15 | 0.15 | 0.15 | 0.15 | 0.15 |
| | Foam stabilizer | [ Parts by mass] | 1.0 | 1.0 | 1.0 | 1.0 | 1.0 | 1.0 |
| | Flame retardant | [ Parts by mass] | 20 | 20 | 20 | 20 | 20 | 20 |
| | Antioxidant 1 | [ Parts by mass] | 1.0 | 1.0 | 1.0 | 1.0 | 1.0 | 1.0 |
| | Antioxidant 2 | [ Parts by mass] | 2.0 | 2.0 | 2.0 | 2.0 | 2.0 | 2.0 |
| | Pigment | [ Parts by mass] | 1.0 | 1.0 | 1.0 | 1.0 | 1.0 | 1.0 |
| | Isocyanate | [ Parts by mass] | 60.97 | 60.97 | 60.97 | 60.97 | 60.97 | 60.97 |
| | | INDEX | 107.3 | 107.3 | 107.3 | 107.3 | 107.3 | 107.3 |
| | Tin catalyst | [ Parts by mass] | 0.11 | 0.13 | 0.18 | 0.11 | 0.13 | 0.18 |
| | Cyclic siloxane | [Parts by mass] | 0 | 0 | 0 | 0.5 | 0.5 | 0.5 |
| | n-Dodecane | [ Parts by mass] | 0 | 0 | 0 | 0 | 0 | 0 |
| Physical | Density | [kg/m³] | 28.7 | 31.0 | 27.6 | 29.8 | 28.8 | 28.4 |
| properties | 25% ILD hardness | [N] | 125 | 130 | 129 | 114 | 133 | 128 |
| | Rebound | [%] | 28.0 | 28.0 | 25.0 | 29.0 | 28.0 | 25.0 |
| | resilience | | | | | | | |
| | Tensile strength | [kPa] | 145 | 135 | 125 | 81 | 95 | 90 |
| | Elongation | [%] | 123 | 136 | 140 | 117 | 125 | 145 |
| | percentage | | | | | | | |
| | Tear strength | [N/cm] | 5.1 | 4.8 | 5.3 | 4.8 | 5.1 | 5.5 |
| | Compression set | [%] | 3.5 | 4.9 | 5.9 | 2.8 | 4.4 | 4.7 |
| | Air flow value | [L/min] | 120 | 82 | 27 | 181 | 106 | 39 |
| VOC | Dodecane | [ppm] | — | — | — | — | — | — |
| value | Total VOC | [ppm] | 439.5 | — | — | 527.0 | — | — |

| | | | | | | | |
|---|---|---|---|---|---|---|---|
| Flammability | Judgement | Pass | — | — | Pass | — | — |

| | | | Reference | | | | |
|---|---|---|---|---|---|---|---|
| | | | Example 4 | Example 1 | Example 2 | Example 3 | Example 4 |
| Blending | Polyol 1 | [ Parts by mass] | 100 | 100 | 100 | 100 | 100 |
| ratio | Polyol 2 | [ Parts by mass] | 5.0 | 5.0 | 5.0 | 5.0 | 5.0 |
| | Foaming agent | [ Parts by mass] | 4.7 | 4.7 | 4.7 | 4.7 | 4.7 |
| | Amine catalyst | [ Parts by mass] | 0.15 | 0.15 | 0.15 | 0.15 | 0.15 |
| | Foam stabilizer | [ Parts by mass] | 1.0 | 1.0 | 1.0 | 1.0 | 1.0 |
| | Flame retardant | [ Parts by mass] | 20 | 20 | 20 | 20 | 20 |
| | Antioxidant 1 | [ Parts by mass] | 1.0 | 1.0 | 1.0 | 1.0 | 1.0 |
| | Antioxidant 2 | [ Parts by mass] | 2.0 | 2.0 | 2.0 | 2.0 | 2.0 |
| | Pigment | [ Parts by mass] | 1.0 | 1.0 | 1.0 | 1.0 | 1.0 |
| | Isocyanate | [ Parts by mass] | 60.97 | 60.97 | 60.97 | 60.97 | 60.97 |
| | | INDEX | 107.3 | 107.3 | 107.3 | 107.3 | 107.3 |
| | Tin catalyst | [ Parts by mass] | 0.23 | 0.11 | 0.13 | 0.18 | 0.23 |
| | Cyclic siloxane | [Parts by mass] | 0.5 | 0 | 0 | 0 | 0 |
| | n-Dodecane | [ Parts by mass] | 0 | 0.5 | 0.5 | 0.5 | 0.5 |
| Physical | Density | [kg/m³] | 27.1 | 29.1 | 28.8 | 28.3 | 27.5 |
| properties | 25% ILD hardness | [N] | 123 | 114 | 129 | 132 | 127 |
| | Rebound | [%] | 29.0 | 30.0 | 28.0 | 21.0 | 17.0 |
| | resilience | | | | | | |
| | Tensile strength | [kPa] | 91 | 89 | 81 | 93 | 91 |
| | Elongation | [%] | 134 | 123 | 134 | 105 | 126 |
| | percentage | | | | | | |
| | Tear strength | [N/cm] | 4.6 | 5.2 | 4.8 | 5.0 | 4.50 |
| | Compression set | [%] | 27.7 | 3.0 | 2.4 | 6.5 | 15.4 |
| | Air flow value | [L/min] | 4 | 184 | 136 | 30 | 12 |
| VOC | Dodecane | [ppm] | — | 13.5 | — | — | — |
| value | Total VOC | [ppm] | — | 445.6 | — | — | — |

| | | | | | | |
|---|---|---|---|---|---|---|
| Flammability | Judgement | — | Pass | — | — | — |

### 2. Evaluation Method

### (1) Apparent Density (Density)

The apparent density was measured according to JIS K 7222:2005.

### (2) Hardness (25% ILD Hardness)

The hardness was measured according to Method D of JIS K 6400-2:2012.

### (3) Rebound Resilience

The rebound resilience was measured according to JIS K 6400-3:2011.

### (4) Tensile Strength, Elongation, and Tear Strength

The tensile strength, elongation, and tear strength were measured according to JIS K 6400-5:2012.

### (5) Compression Set

The compression set was measured according to Method A of JIS K 6400-4:2004 at 50% compression and 70° C. for 22 hours.

### (6) Air Flow Value

The air flow value was measured according to Method A of JIS K 6400-7.

### (7) VOC Value

For the measurement of VOC values, from each sample, 7 mg of a test piece was prepared, the test piece was placed in a glass tube, and a thermal desorption apparatus was used to perform the VOC measurement method specified in “VDA 278 by the German Association of the Automotive Industry”. Specifically, each test piece was heated at a temperature of 90° C. for a time of 30 minutes, and the gas generated during the heating was analyzed by a gas chromatograph mass spectrometer to calculate the VOC value.

### (8) Flammability

The flame retardancy was measured in accordance with the Federal Motor-Vehicle Safety Standards (FMVSS-302). The case corresponding to any of the following cases was judged as “pass”.
Self-extinguished before reaching the reference line
Burnt distance was within 51 mm (within 60 seconds)
Burn rate was 102 mm/min or less

### 3. Results

The results are also shown in Table 1.

Comparative Examples 1-3 show the results of polyurethane foams in which 0.11 parts by mass, 0.13 parts by mass, and 0.18 parts by mass of the tin catalyst were added, respectively, and no additive (cyclic siloxane or hydrocarbon) was added. The air flow values of Comparative Examples 1-3 were 120 L/min, 82 L/min, and 27 L/min, respectively. It was found that as the amount of the tin catalyst increased, the air flow value decreased.

Reference Examples 1-4 show the results of polyurethane foams in which 0.11 parts by mass, 0.13 parts by mass, 0.18 parts by mass, and 0.23 parts by mass of the tin catalyst were added, respectively, and 0.5 parts by mass of the cyclic siloxane was added. In Reference Examples 1-3, the air permeability was improved as compared with Comparative Examples 1-3 to which the same amount of the tin catalyst was added.

Examples 1-4 show the results of polyurethane foams in which 0.11 parts by mass, 0.13 parts by mass, 0.18 parts by mass, and 0.23 parts by mass of the tin catalyst were added, respectively, and 0.5 parts by mass of n-dodecane was added. In Examples 1-4, the air permeability was improved as compared with Comparative Examples 1-3 to which the same amount of the tin catalyst was added. In Examples 1-4, the air permeability was substantially equal to that of Reference Examples 1-4 to which the same amount of the tin catalyst was added.

Therefore, in Examples 1-4, it was confirmed that the air permeability can be improved even when no cyclic siloxane is added.

The total VOC in Example 1 was 445.6 ppm. In Example 1, it was confirmed that the VOC value was practicable. The total VOC in Comparative Example 1 was 439.5 ppm. The total VOC in Reference Example 1 was 527.0 ppm.

Furthermore, dodecane was detected in the polyurethane foam of Example 1. That is, it is understood that the polyurethane foam of the present disclosure can be regarded as a polyurethane foam containing a hydrocarbon having 5 or more and 50 or less carbon atoms and a tin catalyst.

Further, the flammability in Example 1 was “pass”. In Example 1, it was confirmed that the flammability was practicable. The flammability in Comparative Example 1 and Reference Example 1 was also “pass”.

In the above examples, the air permeability of the polyurethane foam was able to be improved without using a cyclic siloxane. In addition, in order to improve the air permeability of the polyurethane foam, it was confirmed that a hydrocarbon can be a substitute for a cyclic siloxane.

The present disclosure is not limited to the examples described in detail above, and various modifications or changes can be made within the scope of the present disclosure.

1.-6. (canceled)

7. A polyurethane foam obtained from a composition obtained by mixing:
a polyol;
a polyisocyanate; and
a tin catalyst,
wherein the composition contains a hydrocarbon having 5 or more and 50 or less carbon atoms, and
the polyurethane foam has an air flow value based on Method A of JIS K 6400-7:2012 of 25 L/min or more.

8. The polyurethane foam according to claim 7, wherein the composition contains a hydrocarbon having 9 or more and 50 or less carbon atoms.

9. The polyurethane foam according to claim 7, wherein the hydrocarbon is at least one selected from the group consisting of n-nonane, n-decane, n-undecane, n-dodecane, n-tridecane, n-tetradecane, n-pentadecane, n-hexadecane, n-heptadecane, n-octadecane, n-nonadecane, and n-eicosane.

10. The polyurethane foam according to claim 7, wherein the hydrocarbon is an isoparaffin.

11. The polyurethane foam according to claim 7, wherein
a polyester polyol is contained as the polyol, and
the content of the polyester polyol is 20 parts by mass or less when the total amount of the polyols is 100 parts by mass.

12. The polyurethane foam according to claim 7, wherein the composition further contains water, and
in the composition, the hydrocarbon is contained in an amount of 1.0 part by mass or less, and the water is contained in an amount of 1 part by mass or more and 10 parts by mass or less with respect to 100 parts by mass of the polyol.
